(19) United States
(12) Patent Application Publication
(10) Pub. No.: US 2013/0277981 A1
(43) Pub. Date: Oct. 24, 2013

(54) Windmill

(71) Applicant: Jeffrey W. Turck, Carthage, NY (US)

(72) Inventor: Jeffrey W. Turck, Carthage, NY (US)

(21) Appl. No.: 13/865,728

(22) Filed: Apr. 18, 2013

Related U.S. Application Data
(62) Division of application No. 13/111,466, filed on May 19, 2011.

(51) Int. Cl. F03D 9/00

(52) U.S. Cl. CPC F03D 9/002
USPC 290/55

(57) ABSTRACT

A windmill including a set of rotating windmill blades (rotating about a substantially horizontal axis of rotation), multiple generators and a power conversion train. The power conversion train includes switching hardware. A first set generators is selectively inserted into the power conversion train under a first range of operating conditions, and a second set of generators is selectively inserted into the power conversion train under a second range of operating conditions. Also, a windmill including a set of rotating windmill blades (rotating about a substantially horizontal axis of rotation) a power conversion train. The power conversion train includes a chain drive system. The power conversion train includes a generator structured and connected to convert kinetic mechanical energy in the power conversion train into electrical energy. the chain drive system includes two sprockets and a chain that is in sprocket/chain engagement with both sprockets. The windmill preferably further includes an electrical energy storage device to store at least a portion of the electrical energy and/or an electricity delivery device to deliver at least a portion of the electrical energy to a utility grid. Preferably, the chain drive system includes adjustment means to adjust the distance between the two sprockets to thereby adjust an amount of slack in the chain.

### CROSS-REFERENCE TO RELATED APPLICATION

The present application relates to and is a divisional application of applicant's co-pending U.S. patent application Ser. No. 13/111,466, the entirety of which is hereby incorporated by reference.

### BACKGROUND OF THE INVENTION

1. Field of the Invention

The present invention relates to windmills and more particularly to relatively small scale windmills used for the generation of utility power and also windmills using alternators (see DEFINITIONS section).

2. Description of the Related Art

U.S. Pat. No. 7,215,037 (“Scalzi”) discloses a wind driven turbine system that may be configured as a vertical axis wind turbine system or as a horizontal axis wind turbine system (see Scalzi at ABSTRACT.) Reference numerals used in this discussion of Scalzi refer to the Scalzi reference and not the drawings of this application. Systems according to Scalzi generally have multiple turbines 20 and multiple generators 30. While the turbines 20 of Scalzi have blades 22, they are not windmill-type blades and these blades have major faces that extend primarily along the radial-axial plane (with respect to the co-ordinate system defined by the axis of rotation). the turbines of Scalzi are enclosed in an enclosure 70. Scalzi also discloses the well-known concern about birds being killed by wind collection devices and suggests that its design with enclosed turbines can be used to reduce this well-known problem. (See Scalzi at column 2, lines 3-50.)

U.S. Pat. No. 6,969,926 (“Conlon”) discloses a windmill with a shaft that drives a chain drive. Conlon's windmill is only disclosed as a machine for pumping water and Conlon does not teach or suggest that its windmill could be used to generate electricity.

U.S. Pat. No. 4,653,982 (“Kojima”) discloses a windmill including a set of windmill blades, an alternator and a centrifugal clutch. The centrifugal clutch will: (i) disengage at low rotational speeds to that the set of windmill blades is not mechanically connected (see DEFINITIONS section) to and do not drive the alternator; but (ii) engage at greater rotational speeds so that the set of blades are mechanically connected to the alternator and so that the rotation of the blades will drive the alternator to convert the kinetic mechanical energy into electrical energy. At column 5, line 48, Kojima discloses that this insertion and removal of its alternator into the power conversion train of the windmill will prevent the alternator from interfering with rapid acceleration of the shaft (and presumably the blades attached to the shaft) under low wind conditions.

The following published documents may also include helpful background information: U.S. patent application 2010/0171314 (“Tackett”).

Description Of the Related Art Section Disclaimer: To the extent that specific publications are discussed above in this Description of the Related Art Section, these discussions should not be taken as an admission that the discussed publications (for example, published patents) are prior art for patent law purposes. For example, some or all of the discussed publications may not be sufficiently early in time, may not reflect subject matter developed early enough in time and/or may not be sufficiently enabling so as to amount to prior art for patent law purposes. To the extent that specific publications are discussed above in this Description of the Related Art Section, they are all hereby incorporated by reference into this document in their respective entirety(ies).

### BRIEF SUMMARY OF THE INVENTION

One aspect of present invention is directed to a windmill including a set of rotating windmill blades (rotating about a substantially horizontal axis of rotation), multiple generators and a power conversion train. The power conversion train includes switching hardware. A first set generators (see DEFINITIONS section) is selectively inserted into the power conversion train under a first range of operating conditions (see DEFINITIONS section), and a second set of generators is selectively inserted into the power conversion train under a second range of operating conditions. The second set of operating conditions is different than the first set of operating conditions. The first set of generators is not identical to the second set of generators, although some or all generator(s) in the first set may also be present in the second set (or vice versa) so long as the first set and the second set are not the same.

There may be additional switch positions corresponding to different (possibly overlapping) sub-sets of generators. The generators are preferably in the form of alternators that are mass produced for use in motor vehicles. The switching hardware preferably includes a centrifugal clutch. The windmill blades are preferably located at an intermediate height above the ground. The power conversion train preferably includes a chain drive system. The windmill preferably further includes directional adjustment hardware that allows the set of rotating windmill blades to rotate (or swivel), as a whole sub-assembly, so that their horizontal axis of rotations rotates in within the horizontal plane.

Another aspect of present invention is directed to a windmill including a set of rotating windmill blades (rotating about a substantially horizontal axis of rotation) a power conversion train (sometimes referred to as a powertrain). The power conversion train includes a chain drive system. The power conversion train includes a generator structured and connected to convert kinetic mechanical energy in the power conversion train into electrical energy. the chain drive system includes two sprockets and a chain that is in sprocket/chain engagement with both sprockets. The windmill preferably further includes an electrical energy storage device to store at least a portion of the electrical energy and/or an electricity delivery device to deliver at least a portion of the electrical energy to a utility grid. Preferably, the chain drive system includes adjustment means to adjust the distance between the two sprockets to thereby adjust an amount of slack in the chain.

Various embodiments of the present invention may exhibit one or more of the following objects, features and/or advantages:

(i) small scale windmill suitable for installation at an individual family's residence;

(ii) windmill that efficiently converts wind power over a wide range of wind speeds;

(iii) a quieter windmill;

(iv) a more reliable and durable windmill;

(v) a less expensive windmill; and/or

(vi) a windmill the reduces or eliminates the killing of birds associated with conventional large scale windmills.

According to an aspect of the present invention, a windmill includes: a frame; a plurality of windmill-style blades; a power conversion train; and an electrical energy output device. The frame rotatably supports the plurality of windmill-style blades so that they rotate about a blade-rotation axis of rotation that is at least substantially horizontal. The frame supports the power conversion train. The power conversion train includes a first shaft, a mechanical switching hardware set, a first generator set and a second generator set. The first generator set includes at least one generator. The second generator set includes at least one generator. The first generator set is different than the second generator set. The mechanical switching hardware set is configurable between at least a first configuration and a second configuration. The mechanical switching hardware is located, structured and/or connected to transmit kinetic energy from the blades to the first generator set when the mechanical switching hardware is in the first configuration. The mechanical switching hardware is located, structured and/or connected to transmit kinetic energy from the blades to the second generator set when the mechanical switching hardware is in the second configuration. The mechanical switching hardware set is further structured, located and/or connected so that it will configure to its first configuration under a first set of operating conditions and it will configure to its second configuration under a second set of operating conditions. The first and second generator sets are structured, connected and or located to convert at least a portion of received kinetic energy into electrical energy and to output that electrical energy to the electrical energy output device.

According to another aspect of the present invention, a windmill includes: a frame; a set of blades; a first shaft; a first loop rotation assembly; a second shaft; a second loop rotation assembly; and a first alternator assembly. The set of blades is sized, shaped, structured and/or located to be driven into rotation by wind. The set of blades and the first shaft are rotatably mechanically connected to the frame. The set of blades is mechanically connected to the first shaft so that rotation of the set of blades will drive rotation of the first shaft about its central axis. The first loop rotation assembly is structured, located, sized, shaped and/or connected to be driven into rotation by rotation of the first shaft and to drive the second shaft to rotate about its central axis such that the rotational speed of the second shaft divided by the rotational speed of the first shaft is equal to a first rotation ratio. The second loop rotation assembly is structured, located, sized, shaped and/or connected to be driven into rotation by rotation of the second shaft and to drive the first alternator assembly to rotate such that the rotational speed of the first alternator assembly divided by the rotational speed of the second shaft is equal to a second rotation ratio. The first alternator assembly is structured and/or connected to transduce its rotational motion into electrical power.

According to another aspect of the present invention, a windmill includes: a frame; a set of blades; a first shaft; a first loop rotation assembly; a second shaft; a second loop rotation assembly; and a first alternator assembly. The frame includes a swiveling portion, a non-swiveling portion and an attachment hardware set. The attachment hardware is structured, located, sized and/or shaped to rotationally mechanically connect the swiveling portion of the frame to the non-swiveling portion of the frame. The set of blades are sized, shaped, structured and/or located to be driven into rotation by wind. The set of blades and the first shaft are rotatably mechanically connected to the swiveling portion of the frame so that the axis of rotation of the swiveling portion of the frame relative to the non-swiveling portion of the frame is at least approximately perpendicular to the axis of rotation of the set of blades relative to the swiveling portion. The first shaft, first loop rotation assembly, second shaft, second loop rotation assembly and first alternator assembly are mechanically connected to the swiveling portion of the frame. The set of blades is mechanically connected to the first shaft so that rotation of the set of blades will drive rotation of the first shaft about its central axis. The first loop rotation assembly is structured, located, sized, shaped and/or connected to be driven into rotation by rotation of the first shaft and to drive the second shaft to rotate about its central axis such that the rotational speed of the second shaft divided by the rotational speed of the first shaft is equal to a first rotation ratio. The second loop rotation assembly is structured, located, sized, shaped and/or connected to be driven into rotation by rotation of the second shaft and to drive the first alternator assembly to rotate such that the rotational speed of the first alternator assembly divided by the rotational speed of the second shaft is equal to a second rotation ratio. The first alternator assembly is structured and/or connected to transduce its rotational motion into electrical power.

### BRIEF DESCRIPTION OF THE DRAWINGS

The present invention will be more fully understood and appreciated by reading the following Detailed Description in conjunction with the accompanying drawings, in which:

FIG. 1 is a schematic view of a first embodiment of a windmill according to the present invention;

FIG. 2A is a schematic representation of two alternative generator set groupings that might be used in conjunction with the first embodiment windmill;

FIG. 2B is a schematic representation of five alternative generator set groupings that might be used in conjunction with the first embodiment windmill;

FIG. 3 is a schematic view of a second embodiment of a windmill according to the present invention;

FIG. 4 is a perspective view of a third embodiment of a windmill according to the present invention;

FIG. 5 is another perspective view of the third embodiment windmill;

FIG. 6 is a perspective view of a portion of the third embodiment windmill;

FIG. 7 is a perspective view of a portion of the third embodiment windmill;

FIG. 8 is another perspective view of another portion of the third embodiment windmill;

FIG. 9 is another perspective view of another portion of the third embodiment windmill;

FIG. 10 is another perspective view of another portion of the third embodiment windmill;

FIG. 11 is another perspective view of another portion of the third embodiment windmill;

FIG. 12 is an orthographic, front, partially cut-away view of an electric ring assembly wherein 180 degree of a peripheral wall of the ring assembly has been cut away to allow viewing of the internal components of the electric ring assembly; and

FIG. 13 is a schematic view of a portion of the third embodiment windmill.

### DETAILED DESCRIPTION OF THE INVENTION

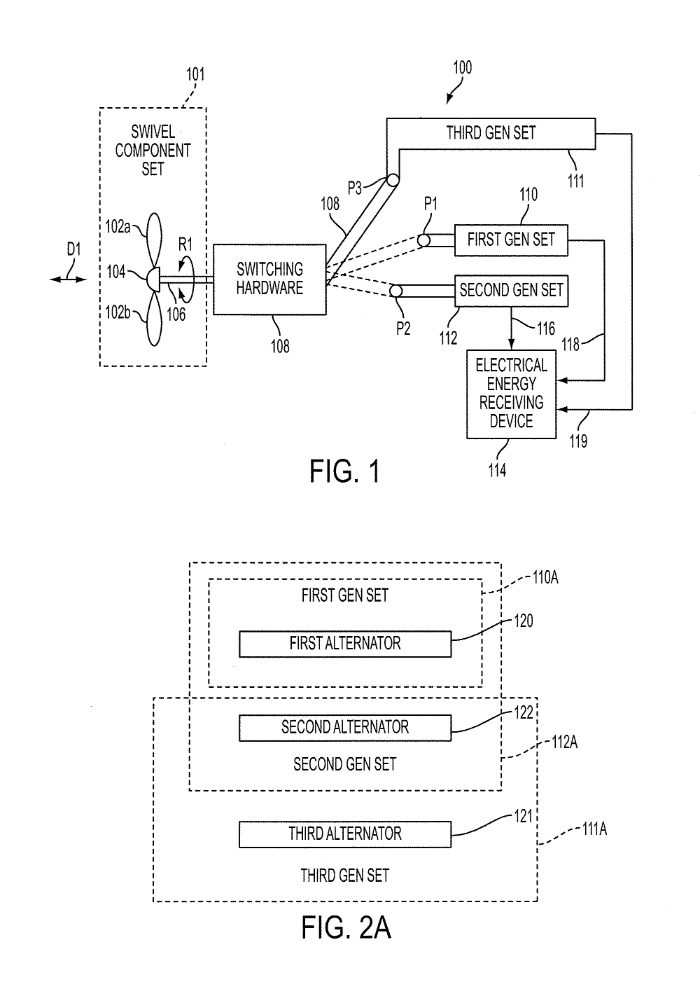

FIG. 1 shows a windmill 100 including: windmill blades 102a, 102b; hub 104; first shaft 106; mechanical switching hardware 108; first generator set 110; second generator set 112; third generator set 111; electrical energy receiving device 114; and electrical energy paths 116, 118, 119. Windmill 100 may include additional components, such as a tail stock, a tower, additional blades, etc.

As in conventional windmill, windmill blades 102a, 102b are shaped and located so that ambient air currents will rotate them about the hub and thereby cause shaft 106 to rotate in the R1 direction. This kinetic energy of the rotation of the blades and shaft is transmitted as kinetic energy through switching hardware 108.

As shown in FIG. 1, the switching hardware has three positions P1, P2 and P3. In the first position P1, the switching hardware is mechanically connected to first generator set 110, and it transmits the kinetic energy to the generator(s) of the first generator set. The generators of the first generator set convert a portion of the kinetic energy into electrical energy which is sent to electrical energy receiving device 114 through path 118.

When operating conditions change, switching hardware 108 will move to the P2 position. In the P2 position, the switching hardware is mechanically connected to second generator set 112, and it transmits the kinetic energy to the generator(s) of the second generator set. The generators of the second generator set convert a at least a portion of the kinetic energy into electrical energy which is sent to electrical energy receiving device 114 through path 116. Alternatively, the first and second generator sets could send their electrical energy to two different electrical energy receiving devices. For example, if the first generator set operates under conditions where it is only capable of making a small amount of electrical energy, then this might be sent to a battery storage device located in the windmill itself, whereas the electrical output of the second generator set, which would be much larger, might be connected to the utility electrical power grid to feed electrical energy into that.

When operating conditions change, switching hardware 108 will move to the P3 position (in fact, the switch is shown in this position in FIG. 1). In the P3 position, the switching hardware is mechanically connected to third generator set 111, and it transmits the kinetic energy to the generator(s) of the third generator set. The generators of the third generator set convert at least a portion of the kinetic energy into electrical energy which is sent to electrical energy receiving device 114 through path 119.

Now the concept of changing operating conditions will be discussed with reference to several examples. One operating condition is the angular velocity of the shaft. In this example, the switch remains at the P1 position when shaft speed is low so that the first generator set is operational when the speed is low. Preferably, the first generator set is designed to make the most of the kinetic energy that exists at low shaft speeds and to efficiently transduce the power at low speed conditions. In this example, when shaft speed picks up, then the switch moves to position P2 and stays there for some range of intermediate shaft speed operating conditions. Because the second generator set is active when the switch is in the P2 position, it is preferable to design the second generator set to perform with optimal efficiency under intermediate shaft speed conditions. In this example, when shaft speed picks up still further, then the switch moves to position P3 and stays there so long as the shaft speed remains high. Because the third generator set is active when the switch is in the P3 position, it is preferable to design the third generator set to perform with optimal efficiency under high shaft speed conditions. When switching between switching hardware positions, the hardware may be structured or controlled to exhibit some latency in switching, which is to say, for example, when switching from P2 to P3 the shaft speed might be required to remain above the P2 range of speeds for a certain amount of continuous time and/or to reach a certain threshold above the nominal breakpoint between the P2 range of speeds and the P3 range of shaft speeds.

Various embodiments of the present invention may have more, or fewer switch positions. In some embodiments of the present invention there may even be a switch position where no generators are connected up, but this is not necessarily preferred. Making at least some generator(s) common to all switch positions, and all respectively corresponding gen sets, can reduce the amount of hardware and/or switch gearing because the generator(s) common to all sets would never need to be switched in or out. In some preferred embodiments of the present invention the blades will turn even in low winds (2 mph or even less) and can still produce D.C. voltage that is worth converting into electricity. In some preferred embodiments, the first gen set can produce up to 12 volts, or more, in winds as low as 4 to 6 mph. These are reasons to have at least one generator connected in during even low wind speed conditions.

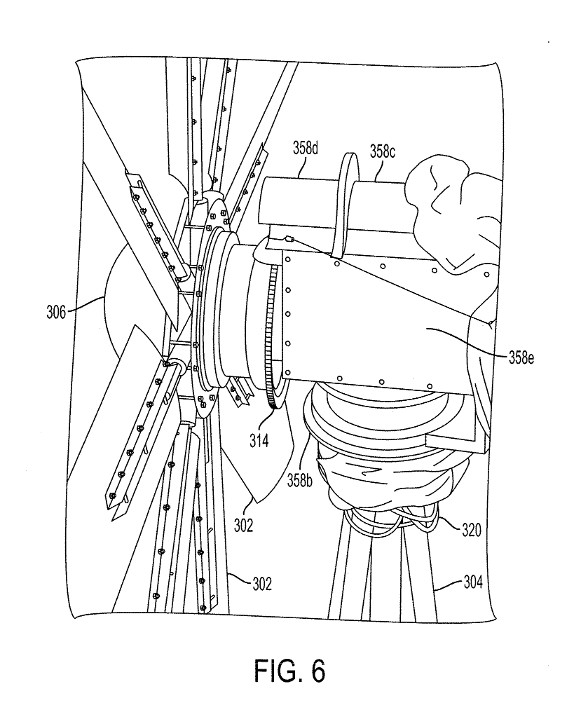

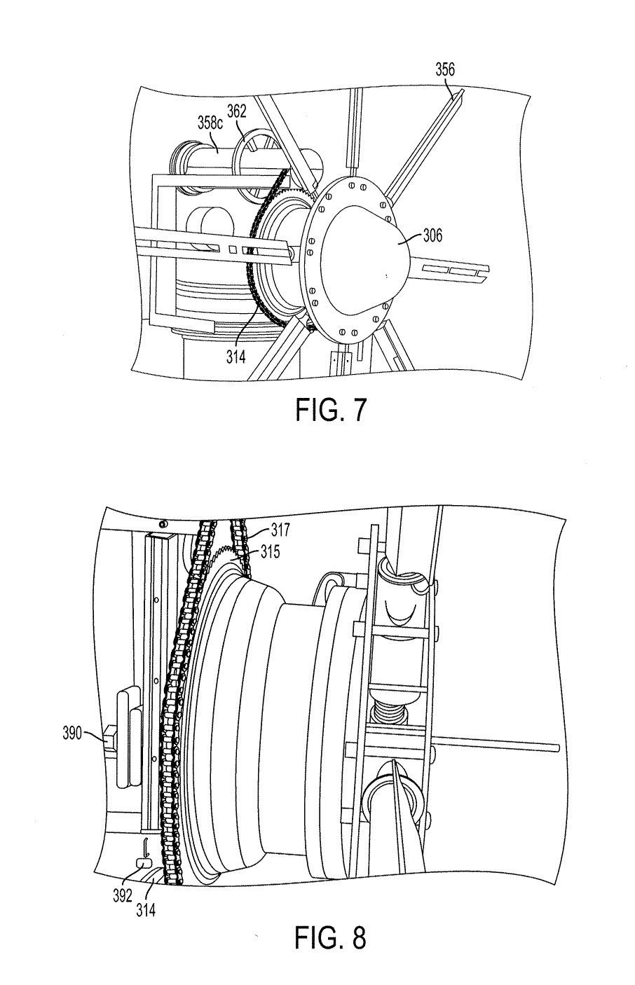

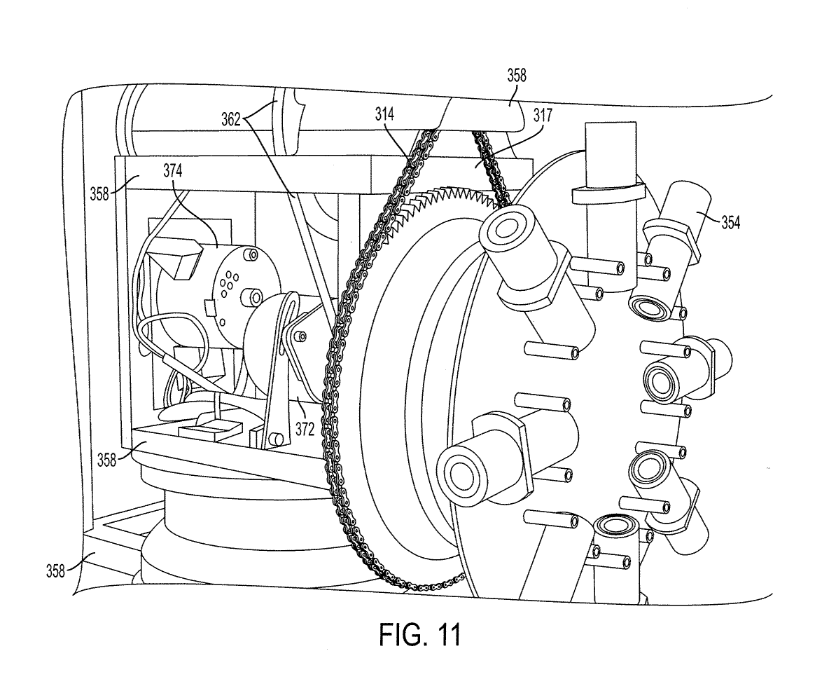

It is further noted that while it is advantageous to have multiple switch positions and multiple different gen sets, the number of switch positions and gen sets should not be unduly increased. More switch positions and more gen sets means more switching hardware and more frequent switching operations during normal operations. This consumes power and creates drag. In other words, the efficiency gains achieved by adding another gen set must be balanced against the losses, initial-build expenses and projected maintenance expenses that will be created by the additional gen set. For example, the preferred embodiment of the present invention that will be discussed below in connection with FIGS. 5 to 12 has only two switch positions and two gen sets (with only one alternator actually being switchable because the other alternator is common to the first and second gen sets). This reduced number of switch positions and switchable alternators helps reduce drag and power consumption caused by switching hardware and switching operations.

In embodiments where the first gen set is limited to a single motor vehicle type alternator and the electrical energy receiving device is a 12 V battery, the small motor vehicle type alternator constituting the first gen set will start turning and producing voltage at wind speeds as low as 2 mph. In this example, the voltage starts out at 1 volt and quickly advances with no substantial mechanical resistance load on the blades and powertrain until the voltage equals the battery's state of charge (approximately 12 volts). When the voltage increases to surpass the battery's state of charge, the small alternator give some resistance. This usually happens at about 3 mph wind speed. If wind speed then increases to 4 to 6 mph, then the 12 volt battery will begin to absorb and store charge generated by the small alternator. Therefore, in this example, power generation starts at such a low wind speed that it is worthwhile to have at least one alternator always connected in, even in the gen set that is connected in at the lowest shaft speed or wind speed.

In embodiments of the present invention where the electrical energy receiving device is in the form of a battery, the windmill system may further include a charge controller (not shown). The charge controller determines whether the battery voltage has reached some predetermined threshold voltage (for example, 14.5 volts). When the threshold voltage is reached, a solenoid is activated to drain the batteries (that is, dump load), through the use of electrical devices, down to a predetermined control voltage level (for example, 12.5 volts). When the batteries have drained back down to the predetermined control voltage level, the charge controller then shuts off dump load then all power generated by the windmill is once again sent to batteries. This kind of system works well in the sense that it keeps the turbine under a load at all times. This ever-present loading tends to slow the motion of and/or reduce mechanical shocks to windmill drivetrain components, thereby preventing excessive stresses and/or strains on the rotor system. At the same time, the ever-present load, created by the fact that at least one alternator is always connected in, helps maintain battery voltages in their working range.

One reason that it can be advantageous to have two (or even more) generator sets according to the present invention is that the power available in the wind is cubic according to velocity-V3 law. For example 10 mph wind 10×10×10=1000. 20 mph wind 20×20×20×=8000. Doubling the wind speed doesn't double the power available, but, rather, it increases the potential by 8 times. Such a steep variation in power with wind speed means that different generator sets will often capture this power more effectively and/or efficiently over different ranges of wind speed, of shaft speed, of wind speed variability, of degree of wind turbulence and so on. Some gen sets are preferably designed to capture low wind energy and the efficiencies of such a gen set will generally be exhausted relatively early in terms of the V3 law. Second (and subsequent) gen sets are tailored for different wind conditions, which are generally impacted by this V3 law. Some specific types of efficiencies that additional generator set(s) can potentially provide include the following: (i) a different set of batteries can be charged at different voltage outputs (for example, 12, 24, and/or 48 volts from the same rotor system); (ii) additional gen set engagements at increasingly higher wind speeds help to control high rotor RPM while some turbines have a means to control their RPM in higher winds it also limits their output to a fraction of the V3 law or they are shut down completely.

As another example of an operative set of operating conditions may be used, windmill 100 might further include a wind speed detector, and the detected wind speed might be used to define the P1, P2 and P3 ranges of operating conditions. As a further alternative, wind speed might be used in conjunction with shaft speed, especially if this kind of scheme could be used to increase efficiency my making sure that the first generator set (“gen set”) is operating when that is optimal and that the second gen set is operating when that is optimal.

As another example of an operative set of operating conditions, ambient temperature might be used to, wholly or partially, control the switching. This control scheme might be preferred when the efficiency and/or integrity of the particular generators used depends upon their temperature, or when some of the generators generate a high degree of heat.

As another example of an operative set of operating conditions, time of day might be used to, wholly or partially, control the switching. This control scheme might be preferred when some of the particular generators used are noisy and could disturb sleep.

As another example of an operative set of operating conditions, the presence of birds might be used. Some type of bird detector (for example, radar, sonar, human watchperson) would have to be used to detect the birds (or the lack of birds). This control scheme might be preferred when one of the generator sets can slow the blades sufficiently that it becomes relatively safer for birds. This control scheme might also be preferred if a noisy generator tends to scare away the birds because this generator could be switched in when birds are detected in the area.

As another example of an operative set of operating conditions, the magnitude and/or frequency of changes in wind direction and/or wind speed might be used. This might be preferred when some of the particular generators used in the various gen sets operate better under fluctuating kinetic energy inputs than others.

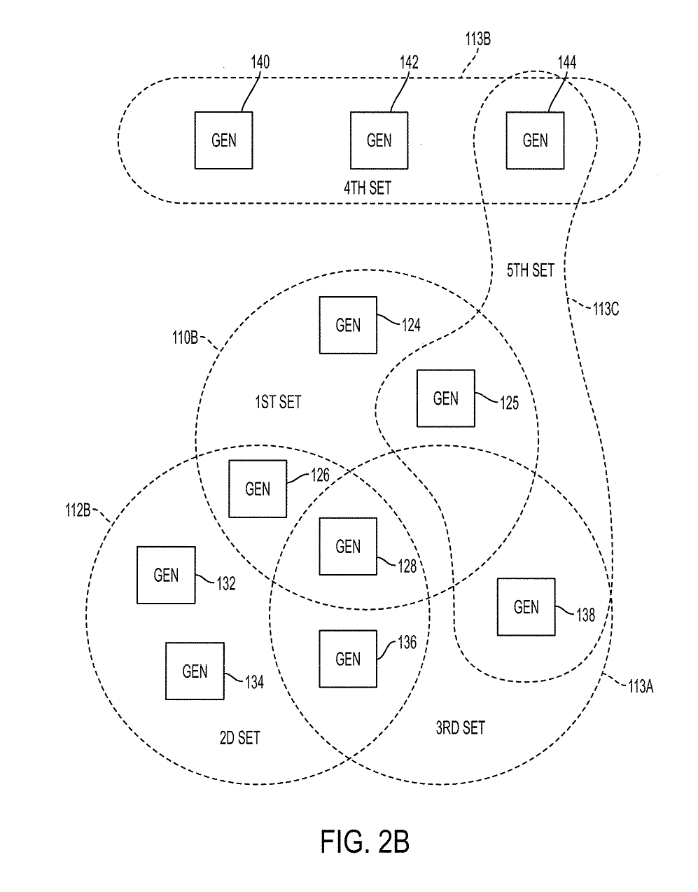

FIG. 2A shows the identity of the generators in the first and second gen sets. Specifically, the first gen set has only a single alternator, called first alternator 120. The second gen set has two generators, first alternator 120 and second alternator 122. It is noted that there is overlap because the first alternator is in both gen sets, even though the sets are different because of the inclusion of the second alternator in the second gen set, but not the first. In embodiment 100, the second gen set includes the additional alternator because this additional alternator only comes into the power train when the shaft speeds are relatively high, and its inclusion will tend to slow down the shaft speed and to ensure that both the first and second alternators are operating at high efficiency when there is a lot of kinetic energy being transmitted through the rotating shaft.

FIG. 2B shows what might happen if embodiment 100 were expanded to include 6 switch positions based on various ranges and/or combinations of operating conditions. In FIG. 2B there are five gen sets 110B, 112B, 113A, 113B, 113C. Each set includes a different sub-set of the eleven generators 124, 125, 126, 128, 132, 134, 136, 138, 140, 142, 144. FIG. 2B shows how the present invention allows creation of a windmill system that can have a flexible and robust response to many different ranges and/or combinations of operating conditions.

Switching hardware 108 is only shown schematically in FIG. 1, largely because there are so many ways (now known and to be developed in the future) to provide the switching. For example, a centrifugal clutch, or a series of centrifugal clutches may be used to mechanically switch the power train between gen sets. Alternatively, electronically controlled clutches and/or computer controlled clutches could be used. Alternatively cams or gears in the powertrain could be moved, inherently by shaft speed or by external control hardware and/or software, switch the gen sets.

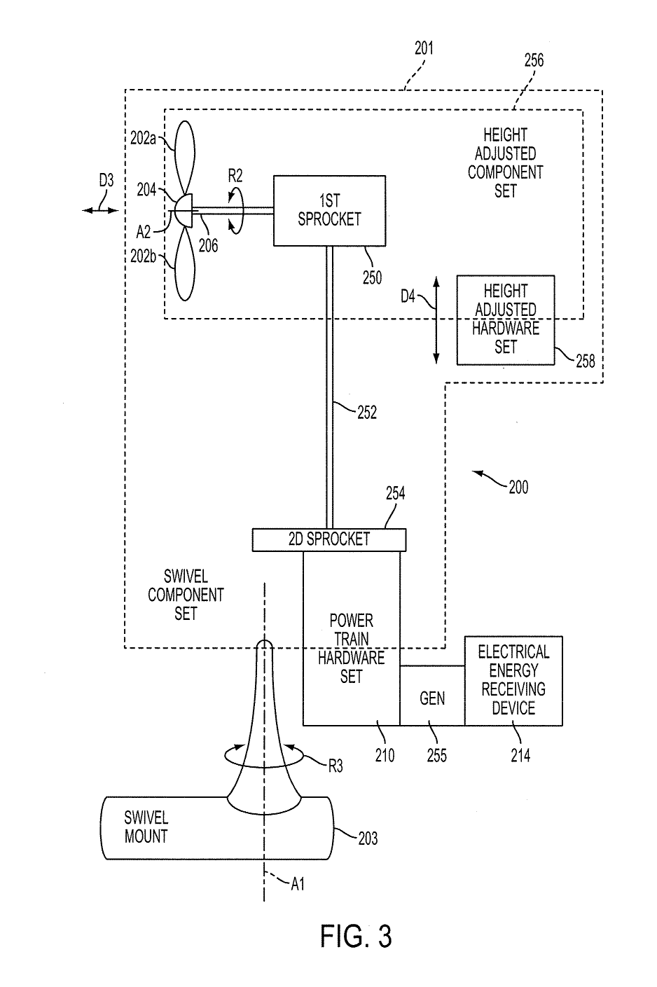

FIG. 3 shows windmill 200 including: swivel component set 201; windmill blades 202a, 202b; hub 204; first shaft 206; first sprocket 250; chain 252; second sprocket 254; powertrain hardware set 210; generator 255; electrical energy storage device 214; swivel mount 203; height adjusted component set 256; and height adjustment hardware set 258. Unlike windmill 100, windmill 200 does not have multiple gen sets. However, windmill 200 has: (i) a swivel mount; (ii) a chain-and-sprocket power transmission path in its powertrain; and (iii) hardware for adjusting the distance between sprockets to take up any undesired slack in the chain. This cluster of features will now be discussed.

Swivel mount 203 is structured to allow swivel component set 201 to rotate, preferably to that the windmill blade set is directly facing the direction of the incoming wind. As is known, this can be accomplished by a tailstock or other hardware. In windmill 200, the components that swivel 201 are: the windmill blades; the hub; the first shaft; the first sprocket; the chain; the second sprocket; part of the power train hardware set and the height adjustment hardware set. In other embodiments, other sub-combinations may be included or excluded from swiveling component set 201, but if the windmill is to include swiveling components then at least the blades and their hub should swivel. In this embodiment, the power train is structured so that some of its components swivel and others do mot, which allows the generator to be a non-swiveling component and to reduce the weight and increase the wind responsiveness of the swiveling action. However, in other embodiments, the generator may be a swiveling component.

In this embodiment, the axis of rotation of the swiveling action A is vertical so that the swiveling component set 20 swivels in a substantially horizontal plane and the axis of the R2 direction rotation of the blades lies in a plane perpendicular to axis A. This is preferred, although other embodiments may have different relative orientations of: (i) their swivel rotation axis; (ii) their blade rotation axis; and/or (iii) the relative orientation between the swiveling action and the axis of rotation of the blades.

Besides its swiveling action, windmill 200 also includes a chain and sprocket power transmission path between sprocket 250, chain 252 and sprocket 254. There are several potential advantages in using a chain-and-sprocket sub-assembly in the powertrain. One potential advantage is that roller chains and sprockets wear and fail less than comparable belt arrangements. Another potential advantage is more efficient transmission of kinetic energy (for example, less heat and less slippage than a comparable belt arrangement). Another potential advantage is that it may be possible to use derailleur gears (see, http://en.wikipedia.org/wiki/Derailleur_gears) as a way of changing the configuration of the power train in response to changes in operating conditions. Such derailleur type gears could be controlled manually or automatically. Such a change in powertrain configuration might just be used to change rotational ratios of components in the gear train, or it might be used to actually switch between gen sets as disclosed above in connection with windmill 100. Such an adjustment could be controlled manually or automatically.

One potential problem with chain-and-sprocket transmission is that the chain may become too tight or too slack, with adverse consequences on power generation performance and/or chain wear and/or breakage. However, in windmill 200, height adjustment hardware set 258 moves the distance between the first sprocket and the second sprocket so that the chain remains at an optimal level of tautness. height adjustment hardware set 258 accomplishes the inter-sprocket distance adjustment by: (i) moving the components of height adjusted component set 256 in the D4 direction; (ii) moving the second sprocket in the D4 direction; and/or (iii) both (i) and (ii). Different component sub-sets could be included in the sub-sets of components that move with the first sprocket and/or the second sprocket, but care must be taken so that any necessary axial alignments between powertrain components are preserved as the sprocket(s) move. While the sprockets move, relative to each other, in the vertical D4 direction in embodiment 200, they could alternately be oriented and move in the horizontal plane or any other plane. While the sprockets move, relative to each other, along the line defined by their centers, in other embodiments, the relative motion may be non-linear.

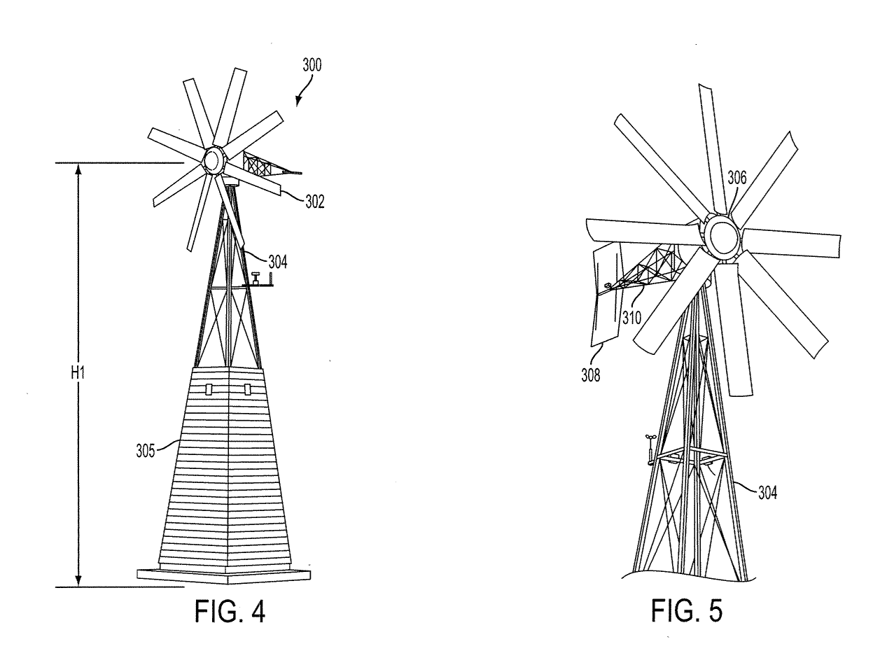

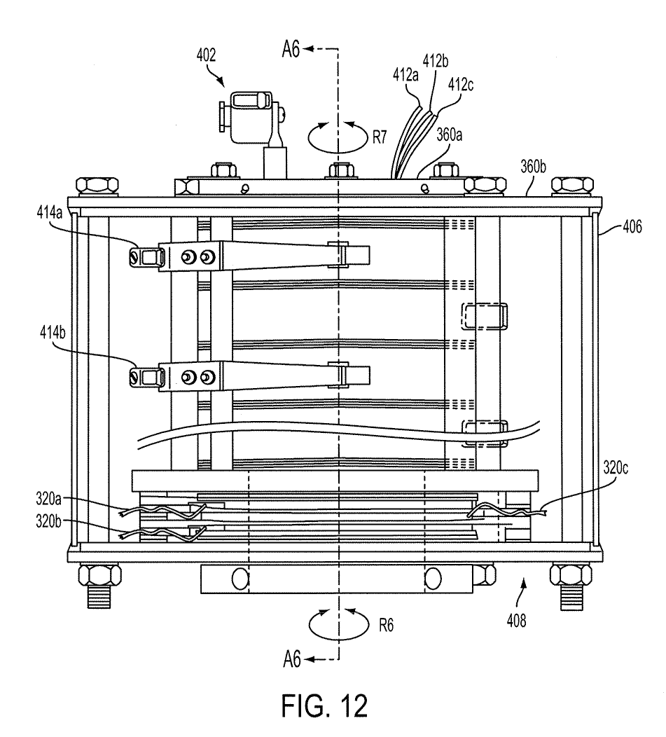

FIGS. 4 to 13 show windmill 300 including: windmill blades 302; tower frame 304; tower enclosure 305; hub 306; tailstock 308; tail frame 310; chain 314; first sprocket 315; second sprocket 317; blade support members 356; support members portion of rotating frame 358a; base member portion of rotating frame 358b; first casing portion of rotating frame 388c; second casing portion of rotating frame 358d; third casing portion of rotating frame 358e; belt transmission assembly 362; first non-rotating output line 320a; second non-rotating output line 320b; third non-rotating output line 320c; electrical ring rotating portion 360a; electrical ring non-rotating portion 360b; blade angle adjustment assemblies 350; blade angle biasing springs 352; blade securement caps 354; first belt and pulley assembly 362; second belt and pulley assembly 363; first alternator 372; second alternator 374; horizontal bolt(s) 390; vertical bolt(s) 392; first shaft 394; second shaft 396; centrifugal clutch 397; and third shaft 398. As shown in FIG. 12, electrical ring assembly 360 includes: non-rotating electrical lines 320a,b.c; cable guide 402; aluminum casing 406; location of hole(s) for passage non-rotating electrical lines 408; brush lugs 414a,b; and rotating electrical lines 412a,b,c.

The height H1 of the blade set is believed to be high enough off of the ground to catch decent wind in many environments, and yet low enough that it will not unduly attract birds who could be hurt by and could interfere with the rotating blades. The axis of rotation of the blades is horizontal, as in a conventional windmill, and the blades are windmill-type blades, rather than turbine-type blades. Enclosure 305 can be used to store batteries (which receive and store electrical power from the windmill) and windmill spare parts and maintenance equipment. Frames 304 and 310 are made of light, but sturdy, metal truss work. While some preferred embodiments of the present invention are advantageous in that they can operate at relatively low heights (for example, the 15 to 50 foot range), but embodiments of the present invention may also be used at other heights, such as on top of silos or high rise buildings (that is, at heights greater than 50 feet).

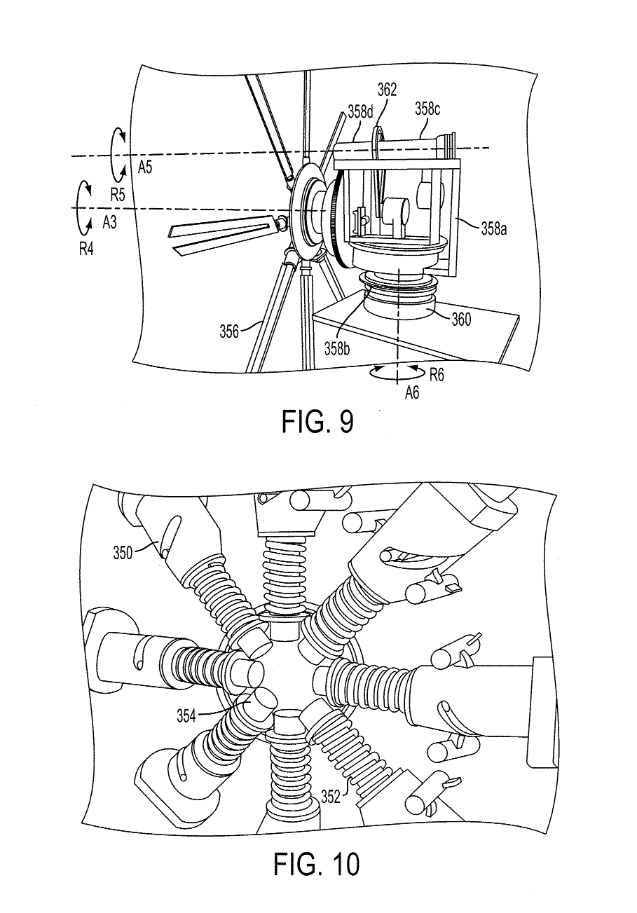

The force of the wind on tailstock 308 causes the entire top of the windmill to rotate in the horizontal plane so that the rotating blades face the wind at an optimal angle. FIG. 9 best shows how the top of the windmill rotates. The blades rotate in a vertical plane in direction R4 about axis A3, while the swiveling components of the windmill rotate in direction R6 about axis A6. These swiveling components include rotating frame 358, windmill blades 302, hub 306, tailstock 308, tail frame 310, chain 314, first sprocket 315, second sprocket 317, blade support members 356, belt transmission assembly 362, electrical ring rotating portion 360a, blade angle adjustment assemblies 350, blade angle biasing springs 352, blade securement caps 354, first alternator 372 and second alternator 374. With reference to FIG. 9 again, the components on top of FIG. 9 rotate with respect to electrical ring 360. As shown in FIG. 12, the electrical ring uses brushes so that the various current paths can be communicated respectively between the non-rotating electrical lines 320a,b,c and the rotating electrical lines 412a,b,c. While this exemplary embodiment can rotate 360 degrees in the R6 direction, other embodiments may have a more limited rage of swiveling motion.

The electricity generated at the generator(s) is conducted to an electric ring (preferably located at the turbine's yaw point and tower top). This electrical ring can be designed for any number of separate power paths as may be desired based on the characteristics of the electrical energy receiving device(s) used in a particular application.

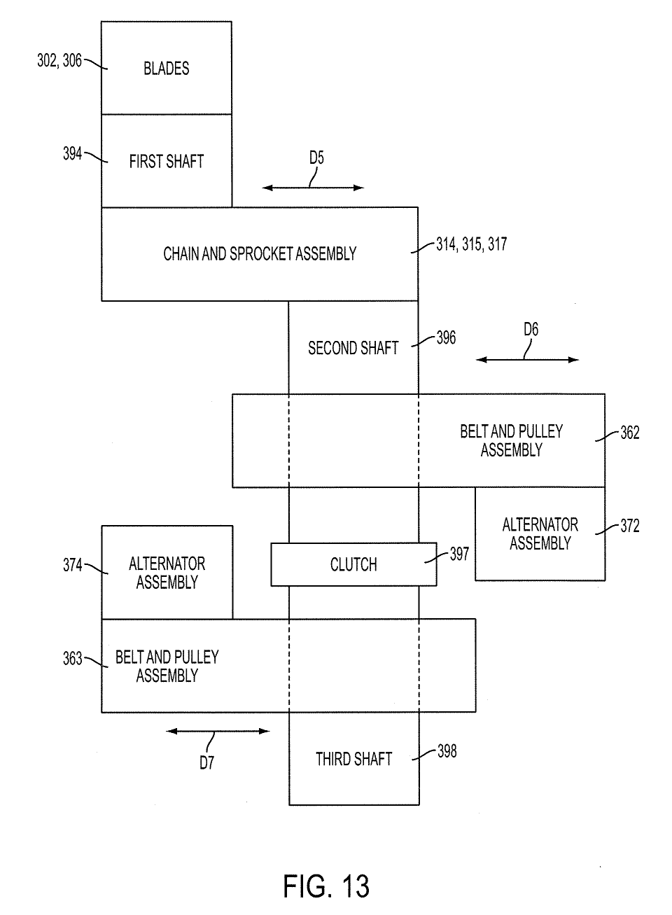

As best shown in FIG. 11, chain 314 is engaged with first sprocket 315 and second sprocket 317. An actuator sub-assembly (not shown) inside casing portions 358c,d can selectively raise and lower the second sprocket, and the shaft (not shown) that is fixed at the center of the second sprocket, in order to adjust the tautness of chain 314. As shown in FIG. 8, horizontal bolt 390 and vertical bolt 392 are used to adjust tightness of chain 314. The horizontal bolt is one of two bolts that compress the entire rotor assembly to the nacelle through vertically slotted holes. The bottom vertical bolt head carries the weight of the rotor and allows for minute adjustments of chain 314 while the horizontal bolt(s) (preferably there are more than one) are loosened. Inside rotating frame portions 358c,d is: second sprocket 317, a 1″ shaft 396 (see FIG. 13) attached to the second sprocket, belt drive pulley (for example, a pulley of belt drive assembly 362) and a centrifugal clutch (see FIG. 13). Centrifugal clutch 397 is designed to connect in alternator 374 (see FIGS. 11 and 13) only when the speed of shaft 396 exceeds a certain angular velocity. This clutch 397 is how windmill 300 switches between its first gen set (alternator 372 only) and its second gen set (alternator 372 plus alternator 374).

FIG. 13 shows the drivetrain position adjustability that has been designed into windmill 300. Specifically, the blades of the windmill turn a first shaft, which forces rotation of a second shaft, offset from the first shaft, through chain and sprocket assembly 314,315,317. The offset between the first and second shafts is adjustable in the D5 direction using the horizontal and vertical bolts as discussed above. The second shaft forces rotation of alternator assembly 372, whose axis of rotation is offset from the second shaft, through belt and pulley assembly 362. The offset between the second shaft and alternator assembly 372 is adjustable in the D6 direction. When the clutch rotationally couples second shaft 396 to third shaft 397 then the rotation of the second shaft will force rotation of the coaxial third shaft. This rotation of the third shaft will then force rotation of alternator assembly 374, whose axis of rotation is offset from the third shaft, through second belt and pulley assembly 363. The offset between the third shaft and alternator assembly 374 is adjustable in the D7 direction. These scheme for individually adjusting the various offsets makes it easy to positionally adjust the position sensitive parts of the drivetrain. Also, the fact that the second and third shafts are offset from the first shaft helps make a more compact package, which can be especially impart for windmills whose drivetrain swivels in the horizontal plane, like windmill 300. However, in other embodiments, there may be no second shaft, and the clutch and the first belt and pulley assembly may be driven directly by the first shaft. Also, other embodiments may have additional shafts, additional alternators, additional chain and sprocket assemblies and/or additional belt and pulley assemblies. Referring to FIGS. 11 and 13, some additional advantages of using a second shaft, and using a chain and sprocket assembly to drive the second shaft will now be discussed. The two sprockets of the chain and sprocket assembly are not the same size. Rather, first sprocket 315 is much larger than second sprocket 317. This means that a single revolution of the windmill blades will cause several revolutions of the second shaft. This results in a relatively high angular velocity for the second shaft which makes it: (i) easier to use centrifugal clutch(es) to switch alternators in and out of the drivetrain; and/or (ii) facilitates the driving of the various alternators at their respective optimal speeds. For example, first alternator 372 is designed to be efficiently driven at a much higher rotational speed than the speed at which the windmill blades usually revolve (at least in the low wind condition which the first gen set is intended to be primarily used for). However, the rotational speed is first increased as the rotational force is transmitted from the first shaft to the second shaft by chain and sprocket assembly 314,315,317, and then the rotational speed is stepped up further belt and pulley assembly 362. In some embodiments of the present invention another belt drive may be used in place chain and sprocket assembly 314,315,317, but when the rotational ratio between the first and second shafts is as large as it is in windmill 300, it may be preferable to use a chain and sprocket drive in order to avoid slippage that can occur at high rotational ratios. Similarly, while belt drives are used to drive the alternator assemblies off the second and third shafts, chain and socket drives might be used here instead, especially for alternators that require such a large ratio that a belt drive would tend to slip. Besides using chain/sprocket assemblies and/or belt/pulley assemblies to adjust rotational speed within the windmill system, it may also be possible to build some degree of rotational speed adjustment into the clutch(es).

Preferably, alternators 372, 374 are designed and manufactured for use in mass-produced motor vehicles. This keeps the cost of the generators down. Preferably, one alternator is always connected into the powertrain and the other generator comes in when shaft speed rises to a level that activates centrifugal clutch 397 and connects second alternator 374 into the power train along with the first alternator. In this way, there are first and second gen sets, with the first gen set including only the first alternator and the second gen set including the first and second alternators. Automotive type alternators use electricity to make a magnet. Permanent magnet alternators (PMA's) already have a magnet built in them therefore they do not waste electricity trying to generate an electromagnetic field especially while not rotating. The similarity lies with the popular and yes mass produced Delco 10 S.I. and 12 S.I. housing and internal components, which is associated with Chevrolet and General motors' products. Renewable energy enthusiasts have been perfecting those changes for years.

In a preferred embodiment, the chain is #41 chain and takes 20-30 horsepower.

In preferred embodiments the torque transmitted by the chain is relatively high as compared with conventional belt-driven windmill power trains.

In windmill 300, electrical ring 360 forms the “front end” of the electrical energy receiving device. Electrical ring 360 is preferably an industrial grade electric ring of the type made by UEA (that is, United Equipment Accessories of Waverly, Iowa), and may include a circuit for each alternator and a circuit for ground. The electrical energy receiving device will generally include other components that receive electricity from the ring through lines 320a,b,c (see FIG. 12). These other components may include a bank of 12 volt batteries and/or an input to the utility power grid.

The ballast may preferably include 5 yards of concrete.

The height H1 is preferably between about 15 feet and 50 feet to reduce bird strikes and also to make the windmill easier to manufacture and install. This low height can be especially important when installing in any sort of proximity to the residences of others. At these relatively low altitudes, the windmill is likely to experience a much greater degree of wind turbulence than very tall and large utility power windmills do. The overall structural integrity and design should be sufficiently strong to withstand the degree of turbulence that the windmill will encounter. Windmills according to the present invention may be placed on rooftops of buildings. One advantage of at least some embodiments of the present invention is the capturing of a lot of wind with a small rotor diameter and slow rotor speed, and then changing all that torque developed into a higher rotational speed at the point where the rotational motion is transmitted to the various alternators in the system. In windmill 300 there is a 1 to 17 ratio between the blade speed and the speed at one of the driven alternators. This means that for rotor speeds of 60-120 rpm, the alternator speed will be 1,020-2040 rpm. As discussed above, the use of chain/sprocket assemblies and/or belt/pulley assemblies can help make this happen.

In one preferred embodiment: (i) a first alternator operates at 12.5 volts at 600 rpm and at 40 amps at 20 mph wind speed; and (ii) a second alternator operates at 50 amps at 20 mph wind speed. In another embodiment a permanent magnet alternator (“PMA”) generates: (i) 14 volts at 2-4 amps in a 5-6 mph wind; (ii)85 amps at 24 mph winds; and (iii) with the potential of 100 amps plus

The sprockets may have their centers cut out (for example, cut out with a water jet). In windmill 300, the main drive sprocket's center was cut out with a water jet to fit the rotor wheel. In windmill 300 the blades are made of aluminum which is one reason why this system can handle the extra weight and torque of the heavy rotor system, 2 PMA's and transmission. In windmill 300, the hub includes a car trailer wheel hub.

### DEFINITIONS

Any and all published documents mentioned herein shall be considered to be incorporated by reference, in their respective entireties, herein to the fullest extent of the patent law. The following definitions are provided for claim construction purposes:

Present invention: means at least some embodiments of the present invention; references to various feature(s) of the “present invention” throughout this document do not mean that all claimed embodiments or methods include the referenced feature(s).

Embodiment: a machine, manufacture, system, method, process and/or composition that may (not must) meet the embodiment of a present, past or future patent claim based on this patent document; for example, an “embodiment” might not be covered by any claims filed with this patent document, but described as an “embodiment” to show the scope of the invention and indicate that it might (or might not) be covered in a later arising claim (for example, an amended claim, a continuation application claim, a divisional application claim, a reissue application claim, a re-examination proceeding claim, an interference count); also, an embodiment that is indeed covered by claims filed with this patent document might cease to be covered by claim amendments made during prosecution.

First, second, third, etc. (“ordinals”): Unless otherwise noted, ordinals only serve to distinguish or identify (e.g., various members of a group); the mere use of ordinals shall not be taken to necessarily imply order (for example, time order, space order).

Electrically Connected: means either directly electrically connected, or indirectly electrically connected, such that intervening elements are present; in an indirect electrical connection, the intervening elements may include inductors and/or transformers.

Mechanically connected: Includes both direct mechanical connections, and indirect mechanical connections made through intermediate components; includes rigid mechanical connections as well as mechanical connection that allows for relative motion between the mechanically connected components; includes, but is not limited, to welded connections, solder connections, connections by fasteners (for example, nails, bolts, screws, nuts, hook-and-loop fasteners, knots, rivets, quick-release connections, latches and/or magnetic connections), force fit connections, friction fit connections, connections secured by engagement caused by gravitational forces, pivoting or rotatable connections, and/or slidable mechanical connections.

generator: any machine that converts mechanical energy to electrical energy.

alternator: a generator (see DEFINITIONS section) in the form of a small rotating machines of the type generally driven by automotive and other internal combustion engines; not all generators are alternators; for example, large scale generators used by utilities to generate electrical power would no be considered as alternators.

range of operating conditions: any combination of one or more operating conditions, even if some or all of the operating conditions are binary conditions that are not susceptible to continuous ranges subsuming more than one discrete value.

supports: directly mechanically supports and/or indirectly mechanically supports through intermediate components.

power conversion train (or powertrain): any set of mechanical components that transfers kinetic energy to a generator; while powertrains typically include rotating shafts, various kinds of gears, belts, roller chains, cams, followers, driven wheels, etc., none of these components are necessarily required (absent an affirmative indication to that effect).

Shaft: may be a single piece shaft, or made of multiple pieces; not necessarily cylindrical.

Loop rotation transmission assembly: a chain-and-sprocket assembly, a belt and pulley assembly or other assembly that uses a loop to transmit rotational motion from one shaft to another.

Unless otherwise explicitly provided in the claim language, steps in method steps or process claims need only be performed in the same time order as the order the steps are recited in the claim only to the extent that impossibility or extreme feasibility problems dictate that the recited step order be used. This broad interpretation with respect to step order is to be used regardless of whether the alternative time ordering(s) of the claimed steps is particularly mentioned or discussed in this document—in other words, any step order discussed in the above specification shall be considered as required by a method claim only if the step order is explicitly set forth in the words of the method claim itself. Also, if some time ordering is explicitly set forth in a method claim, the time ordering claim language shall not be taken as an implicit limitation on whether claimed steps are immediately consecutive in time, or as an implicit limitation against intervening steps.

What is claimed is:

1. A windmill comprising:
a frame;
a set of blades;
a first shaft;
a first loop rotation assembly;
a second shaft;
a second loop rotation assembly; and
a first alternator assembly;
wherein:
the set of blades is sized, shaped, structured and/or located to be driven into rotation by wind;
the set of blades and the first shaft are rotatably mechanically connected to the frame;
the set of blades is mechanically connected to the first shaft so that rotation of the set of blades will drive rotation of the first shaft about its central axis;
the first loop rotation assembly is structured, located, sized, shaped and/or connected to be driven into rotation by rotation of the first shaft and to drive the second shaft to rotate about its central axis such that the rotational speed of the second shaft divided by the rotational speed of the first shaft is equal to a first rotation ratio;
the second loop rotation assembly is structured, located, sized, shaped and/or connected to be driven into rotation by rotation of the second shaft and to drive the first alternator assembly to rotate such that the rotational speed of the first alternator assembly divided by the rotational speed of the second shaft is equal to a second rotation ratio; and
the first alternator assembly is structured and/or connected to transduce its rotational motion into electrical power.

2. The windmill of claim 1 wherein the first rotation ratio multiplied by the second rotation ratio is at least 17.

3. The windmill of claim 1 wherein:
the first loop rotation assembly is a chain-and-sprocket assembly; and
the second loop rotation assembly is a belt-and-pulley assembly.

4. A windmill comprising:
a frame;
a set of blades;
a first shaft;
a first loop rotation assembly;
a second shaft;
a second loop rotation assembly; and
a first alternator assembly;
wherein:
the frame includes a swiveling portion, a non-swiveling portion and an attachment hardware set;
the attachment hardware is structured, located, sized and/or shaped to rotationally mechanically connect the swiveling portion of the frame to the non-swiveling portion of the frame;
the set of blades is sized, shaped, structured and/or located to be driven into rotation by wind;
the set of blades and the first shaft are rotatably mechanically connected to the swiveling portion of the frame so that the axis of rotation of the swiveling portion of the frame relative to the non-swiveling portion of the frame is at least approximately perpendicular to the axis of rotation of the set of blades relative to the swiveling portion;
the first shaft, first loop rotation assembly, second shaft, second loop rotation assembly and first alternator assembly are mechanically connected to the swiveling portion of the frame;
the set of blades is mechanically connected to the first shaft so that rotation of the set of blades will drive rotation of the first shaft about its central axis;
the first loop rotation assembly is structured, located, sized, shaped and/or connected to be driven into rotation by rotation of the first shaft and to drive the second shaft to rotate about its central axis such that the rotational speed of the second shaft divided by the rotational speed of the first shaft is equal to a first rotation ratio;
the second loop rotation assembly is structured, located, sized, shaped and/or connected to be driven into rotation by rotation of the second shaft and to drive the first alternator assembly to rotate such that the rotational speed of the first alternator assembly divided by the rotational speed of the second shaft is equal to a second rotation ratio; and
the first alternator assembly is structured and/or connected to transduce its rotational motion into electrical power.

5. The windmill of claim 4 further comprising an electrical ring that is electrically connected to the first alternator assembly and receives the electrical power transduced by the first alternator assembly.

6. The windmill of claim 4 wherein the first rotation ratio multiplied by the second rotation ratio is at least 17.

7. The windmill of claim 4 wherein:
the first loop rotation assembly is a chain-and-sprocket assembly; and
the second loop rotation assembly is a belt-and-pulley assembly.
